(19) United States
(12) Patent Application Publication
(10) Pub. No.: US 2002/0120497 A1
(43) Pub. Date: Aug. 29, 2002

(54) System and method for operating an awards redemption program

(76) Inventor: Crispin J.B. King, Bucks (GB)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 09/792,450

(22) Filed: Feb. 23, 2001

(51) Int. Cl. G06F 17/60

(52) U.S. Cl. 705/14; 705/26

(57) ABSTRACT

A system and method for operating an awards redemption program having at least one customer where each customer has at least one participant and the program has award points redeemable for awards. Each customer creates a program profile defining at least one electronic catalog having at least one award selected from a collection of awards. Each participant accesses at least one of the electronic catalogs created by the customer associated with the participant in a language associated with the participant. Each participant requests an award redemption for at least one of the awards of the accessed electronic catalog. Each of the awards has a price in award points inclusive of charges associated with the redeeming participant. The award redemption requests are processed and fulfilled.

### BACKGROUND OF THE INVENTION

1. Field of the Invention

The present invention relates to the field of redemption programs. In particular, this invention relates to a method and system for operating an awards redemption program wherein each of the awards has a price in award points inclusive of charges associated with the redeeming participant.

2. Description of the Prior Art

Redemption programs (hereinafter, “programs”) provide companies (hereinafter, “customers”) with a method for allowing employees, members, volunteers, contractors, distribution-channel personnel, and other consumers (hereinafter, “participants”) to redeem awards. For more information regarding motivation or recognition programs, refer to: FILTER PROCESSOR AND METHOD FOR IMPLEMENTING A PROGRAM, U.S. Pat. No. 5,956,695 by Carrithers et al., assigned to Maritz Inc., incorporated herein by reference.

However, there is a need for a system which stores and displays multiple catalogs where each catalog is customized per country for each customer to reflect the shipping fees, duties, taxes, and currency of the redeeming participant in award points and to reflect the language of the redeeming participant. There is also a need for a web-based system for selection of awards by the redeeming participant, processing of award orders, and fulfillment of award orders on an international basis for potential operation from any country for participants in any country with awards delivered from the most cost effective location.

### SUMMARY OF THE INVENTION

It is an object of this invention to provide a system for storing and displaying multiple catalogs where each catalog is customized per country for each customer to reflect the shipping fees, duties, taxes, and currency of the redeeming participant in award points and to reflect the language of the redeeming participant.

It is another object of this invention to provide a web-based system for selection of awards by the redeeming participant, processing of award orders, and fulfillment of award orders on an international basis for potential operation from any country for participants in any country with awards delivered from the most cost effective location.

It is another object of this invention to provide a system for award redemption which includes a communications campaign modified by the customer and presented to the participant.

It is another object of this invention to provide a system for award redemption in which participants redeem awards via a wireless telecommunications device enabled with the wireless application protocol.

In one form, the invention includes a method for operating an awards redemption program having at least one customer. Each customer has at least one participant. The program has award points redeemable for awards. The method comprises the steps of:

allowing each customer to create a program profile defining at least one electronic catalog having at least one award selected from a collection of awards;

allowing each participant to access at least one of the electronic catalogs created by the customer associated with the participant in a language associated with the participant;

allowing each participant to request an award redemption for at least one of the awards of the accessed electronic catalog;

processing the award redemption request; and

fulfilling the award redemption request, wherein each of the awards of the accessed electronic catalog has a price in award points inclusive of charges associated with the redeeming participant.

In another form, the invention includes a system for operating an awards redemption program having at least one customer. Each customer has at least one participant. The program has award points redeemable for awards. The system comprises a creation system, a storage system, a redemption system, a processing system, and a fulfillment system. The creation system allows each customer to create a program profile defining at least one electronic catalog having at least one award selected from a collection of awards. The storage system allows each participant to access at least one of the electronic catalogs created by the customer associated with the participant in a language associated with the participant. The redemption system allows each participant to request an award redemption for at least one of the awards of the accessed electronic catalog. The processing system processes the award redemption request. The fulfillment system fulfills the award redemption request. Each of the awards of the accessed electronic catalog has a price in award points inclusive of taxes, duties, and shipping charges associated with the redeeming participant. The price reflects the exchange rate associated with the redeeming participant.

In another form, the invention includes a system for operating an awards redemption program having at least one customer. Each customer has at least one participant. The program has award points redeemable for awards. The system comprises means for allowing each customer to create a program profile defining at least one electronic catalog having at least one award selected from a collection of awards. The system further comprises means for allowing each participant to access at least one of the electronic catalogs created by the customer associated with the participant in a language associated with the participant. The system further comprises means for allowing each participant to request an award redemption for at least one of the awards of the accessed electronic catalog. The system further comprises means for processing the award redemption request. The system further comprises means for fulfilling the award redemption request. Each of the awards of the accessed electronic catalog has a price in award points inclusive of charges associated with the redeeming participant.

Other objects and features will be in part apparent and in part pointed out hereinafter.

### BRIEF DESCRIPTION OF THE DRAWINGS

FIG. 1 is a block diagram of a preferred embodiment of the method and system of the invention illustrating the main components of the system.

FIG. 2 is a flow chart of one embodiment of the method and system of the invention illustrating operation of the awards redemption program.

FIG. 3 is a flow chart of a preferred embodiment of the method and system of the invention in which a customer creates and maintains a program.

FIG. 4 is a flow chart of a preferred embodiment of the method and system of the invention in which a participant enrolls in the program to enable award redemption.

FIG. 5 is a flow chart of a preferred embodiment of the method and system of the invention illustrating participant interaction with the program.

FIG. 6 is a flow chart of a preferred embodiment of the method and system of the invention illustrating the service support center interaction with the program.

Corresponding reference characters indicate corresponding parts throughout the drawings.

### DETAILED DESCRIPTION OF PREFERRED EMBODIMENTS

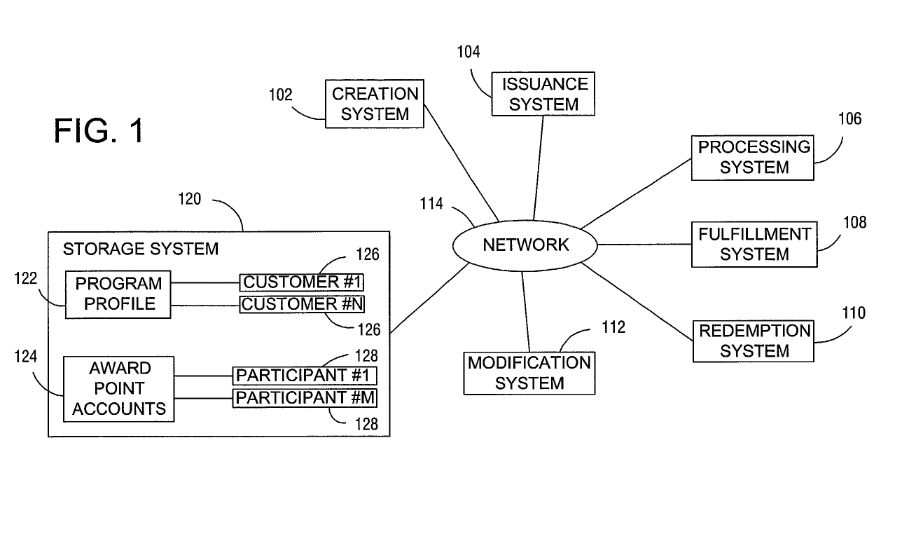

In general, a system and method (hereinafter, “the system 100”) of the invention as shown in block diagram form in FIG. 1. The system 100 includes an awards redemption program (hereinafter, “program”) with at least one customer 126. Each customer 126 has at least one participant 128 who redeems award points for awards. Each of the awards has a price in award points inclusive of charges associated with the redeeming participant 128 such as taxes, duties, and shipping fees. The price also reflects the exchange rate associated with the redeeming participant 128. A supplier provides the system 100.

Referring first to FIG. 1, a block diagram shows the main components of the system 100 which include a creation system 102, an issuance system 104, a processing system 106, a fulfillment system 108, a redemption system 110, a modification system 112, and a storage system 120. The main components of the system 100 are interconnected by a network 114. The creation system 102 allows each customer 126 to create a program profile 122 defining at least one electronic catalog having at least one award selected from a collection of awards. The program profile 122 includes a specific electronic catalog for each country identified by the customer 126. The program profile 122 also includes a communications campaign modifiable by the customer 126. The communications campaign is presented to the participants 128 of the customer 126 when the participants 128 access the electronic catalogs. In the embodiment where the program is accessible via a web page, the communications campaign includes graphical elements associated with the web page. The customer 126 or the administrator modifies the communications campaign to include text, graphics and other branding specific to the customer 126. The customer 126 coordinates selection of the awards to match specific communications campaigns. The program profile 122 also includes program duration, participant information, countries in which the program is operated, and awards used in the program. The electronic catalog also contains information about the selected awards including, but not limited to, pictures and descriptions of the awards.

International customers with participants 128 in multiple countries have the ability to create the electronic catalogs for each country specified by the customer 126 so that the catalogs result in international redemptions capability. In one embodiment, the system 100 allows each customer 126 to create eighty (80) electronic catalogs to offer award redemption in eighty (80) countries. Each participant 128 may have access to multiple electronic catalogs, but each participant 128 only has access to those electronic catalogs specified by the customer 126 associated with the participant 128. One or more of the creation system, the storage system, the redemption system, the processing system, and the fulfillment system operate in the same or different countries. That is, the system 100 can be distributed across several different countries. Participants redeem awards from multiple different countries.

In one embodiment, the program is a web site accessible by the participant 128 via the network 114. The supplier creates the collection of awards from which each customer 126 selects awards to be available for redemption by the participants 128 during the program. The issuance system 104 issues award points to each participant 128. In one embodiment, the issuance system 104 issues award points based on a determination by the customer 126 of an allocation of award points for each participant 128. That is, after the customer 126 allocates the award points for each participant 128, the issuance system 104 issues the allocated amount of award points to each participant 128. In an alternate embodiment, the system 100 allocates and issues the award points to each participant 128. The system 100 allocates according to business rules supplied by the customer 126.

The redemption system 110 allows each participant 128 to request an award redemption for at least one of the awards in the electronic catalog. The participants 128 access the electronic catalogs identified in a participant profile. The participant profile includes one or more of the following: the email address of the participant 128, the programs in which the participant 128 is enrolled, and the shipping address of the participant 128. The participant 128 browses the electronic catalogs to which the participant 128 has access and requests an award redemption after selecting at least one of the awards from the accessible electronic catalogs. The redemption system 110 includes a shopping cart function (described below).

The processing system 106 processes the award redemption request. Such processing includes, but is not limited to, accessing an award point account 124 of the redeeming participant 128 to obtain the amount of the award points available to the redeeming participant 128. The processing system compares the amount of award points available with a total price for all the selected awards to determine if the redeeming participant 128 has sufficient award points to redeem the selected awards. If sufficient award points exist, the processing system decreases the amount of award points associated with the redeeming participant 128 by the total price of the selected awards. The processing system also generates a purchase order for the selected awards for use by the fulfillment system 108. The purchase order identifies the selected awards and information relating to the redeeming participant 128.

The fulfillment system 108 fulfills the award redemption request by utilizing the purchase order. The fulfillment system 108 includes, but is not limited to, determining the most cost effective award partner from which to deliver the selected awards to the redeeming participant 128, authorizing delivery of the selected award to the redeeming participant 128, and notifying the participant 128 preferably via email of the delivery including the order number. The most cost effective award partner can deliver the selected awards for the lowest charges. The delivery notification email includes the order number associated with the delivery and a description of the return policy for delivered awards. To return a delivered award, the participant 128 completes a fax-back returns form or email returns form and sends the delivered award to the supplier.

The modification system 112 allows the customers 126 to modify the program profile 122 and/or the participant profile. In particular, each customer 126 modifies one or more of the following of the previously created program profile 122: program duration, participant information, countries in which the program is operated, and awards used in the program. Each customer 126 also modifies the participant profile for each participant 128 by selecting the electronic catalogs available to each participant 128 associated with the customer 126. In one embodiment, the participant profiles are stored in a Customer Information Management System (CIMS) database for access by the system 100. The storage system 120 allows each participant 128 to access at least one of the electronic catalogs created by the customer 126 associated with the participant 128 in a language associated with the participant 128. Each of the N customers 126 stores their program profile 122 in the storage system 120. Account information such as the amount of the award points for each of the M participants 128 is stored within the storage system 120 in the award point account 124 for each participant 128. The account information also includes data indicating transactions by each participant 128, such as redeeming awards or browsing the electronic catalogs.

The network 114 is any medium for transmitting and receiving data between any of the systems in FIG. 1. The medium can be wired and/or wireless. The network 114 includes, but is not limited to, the Internet, an intranet, a wide area network, and a local area network. Those skilled in the art will recognize that the invention does not require any particular configuration of either the network 114 or the computing devices connected thereto.

In one embodiment, the administrator creates the program profile 122 by queuing a series of instructions on a server associated with the creation system 102. The queued instructions are executed at a later time to create the program profile 122. Similarly, the administrator modifies the program profile 122 by queuing a series of instructions on a server associated with the modification system 112. The queued instructions are executed at a later time to modify the program profile 122.

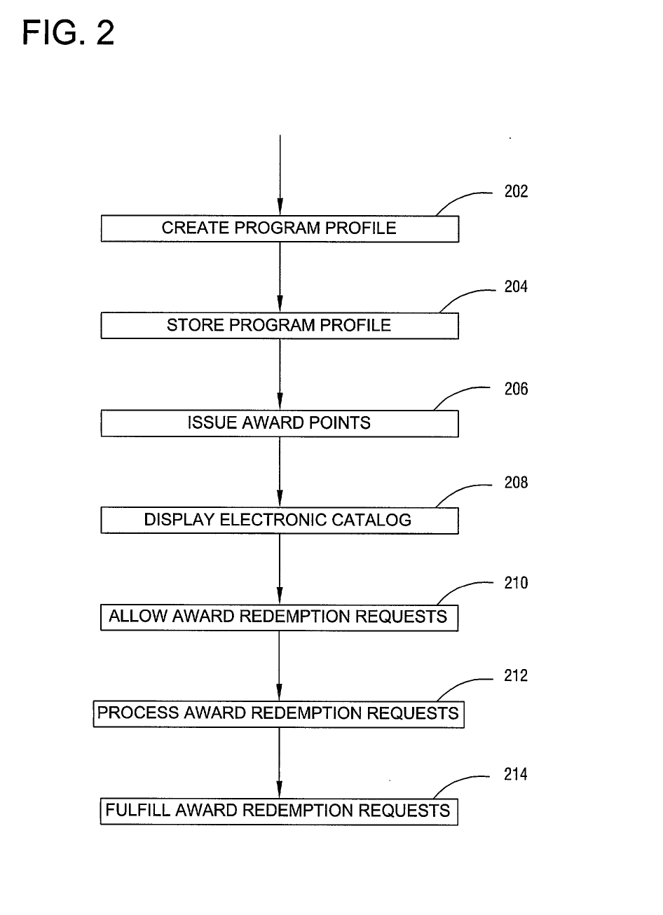

Referring next to FIG. 2, a flow chart illustrates operation of the awards redemption program. According to preferences of the customer 126, the system 100 creates at 202 the program profile 122, stores at 204 the program profile 122, and issues at 206 award points to each participant 128. The system 100 displays at 208 the electronic catalog to participants 128, allows at 210 the participants 128 to request award redemptions, then processes at 212 and fulfills at 214 the award redemption requests.

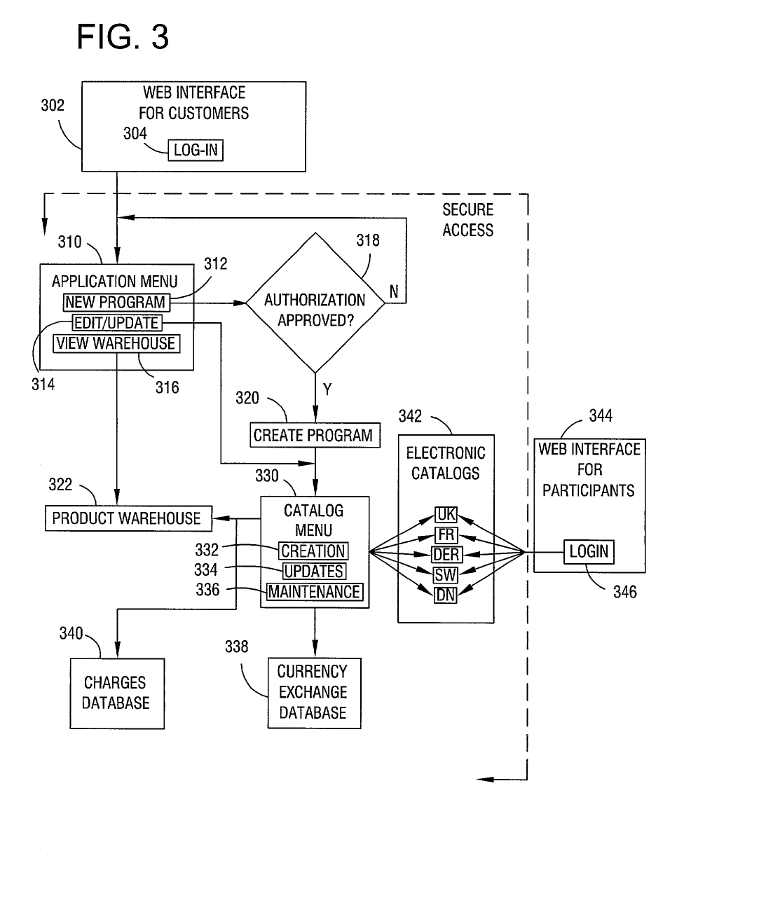

Referring next to FIG. 3, a flow chart illustrates the customer 126 creating and maintaining the program which is accessible via a program website. Program creation includes creating the program profile 122, configuring the identity and content of the program website, activating the program website, and commencing program operation. A supplier administrator securely accesses at 302 an application menu 310 through a web browser or other web interface by logging in at 304 with a user name and password. A series of software-application profile wizards guide the administrator in creating at 312 a new program profile 122, editing/updating at 314 an existing program profile 122, and viewing at 316 an award database. The administrator creates the program profile 122 according to customer preferences.

To create the program profile 122, the administrator verifies at 318 that the customer 126 has received authorization from the supplier to create the program profile 122. The supplier authorizes the customer 126 after the customer 126 has properly contracted with the supplier and has provided the preferences needed to create the program profile 122. If authorization is not approved, the administrator returns to the application menu. If authorization is verified, the administrator creates at 320 the program profile 122. The customer preferences include program specific information such as a customer name, program name, program duration specified by an end date, award redemption start and end dates, countries for which a specific electronic catalog will be created, a number of expected users, a designated approving authority (approver) affiliated with the customer 126, a designated supplier administrator, and a specified language of the program. The program profile 122 also contains a list of the participants 128 eligible to enroll in the program and a list of the countries associated with each participant 128. The approver is a person familiar with the customer preferences. The customer 126 also provides financial information relating to the program. The financial information includes a billing currency, a fixed rate one billing unit in GBP and EUR, a fixed translation of points, billing in points, billing for redemption or issuance, billing on goods , a price guide uplift/decrease percentage, and a variable price field. The exchange rates are fixed for each program and drawn from a conversion table that can be manually changed if required. The customer 126 also specifies the awards to be used in each program by selecting awards from a collection of awards. The customer selects awards from the collection of awards by accessing an award database. The awards include products and services. The awards are categorized by brand name, product line, lifestyle category, price, source, specification, size, quality, and suitability.

Each award in the award database contains award details and costing information. The award details include, but are not limited to, an item number, an award description, and a category. The categories facilitate maintenance of award offerings. The costing information includes, but is not limited to, a cost price, a shipping fee, a high street price, an effective date, a value-added tax (VAT) code, a size and weight of the award (where applicable), an excise duty, and a client subsidy. The costing information also includes a country code, an order processing field, an exclusion field, and a source country field. The country code specifies the countries in which the award is available. The order processing field allows inclusion of the order processing charges paid by the participant 128. The exclusion field enables the exclusion of an award from a particular country. The source country field indicates the country of origin for the award to calculate shipping and tax costs when the electronic catalogs are created or updated. The source country field also provides billing details to the shipping partners. The administrator records changes to the award details and the costing information in a history log associated with the program profile 122.

A formula for calculating a catalog price of each award in award points to be displayed in the electronic catalogs is shown below. Each award receives the catalog price in award points inclusive of shipping, duty, taxes, and exchange rates for the country of origin. The formula is applied in reverse later in the cycle to generate the fees for each shipping partner or award partner.

((RP×UP)×BC/LCC+STC)×AP/BC=P, or (1)

((Retail Price RP×Uplift Percentage UP)×Billing Currency BC/Local Cost Currency LCC+Shipping and Tax Costs STC Based on Country of Origin and the Electronic Catalog Being Populated)×Award Points AP per Billing Currency BC=Price P in Award Points.

The retail price RP is the recommended retail price or the local cost price of the award increased or decreased by the uplift percentage UP. The billing currency BC to local cost currency LCC ratio converts the adjusted retail price into the billing currency designated by the customer 126. The shipping fees, duties, and taxes STC in the billing currency are then added to the converted, adjusted retail price to obtain the catalog price in the billing currency. The country of origin and the electronic catalog associated with the award affect the shipping fees, duties, and taxes. The catalog price in the billing currency is then converted to a catalog price in award points P by the fixed translation of award points; i.e., multiplying by an award points AP per billing currency BC ratio.

The administrator creates the program profile 122 based on the preferences of the customer 126 and selects appropriate computing hardware to implement the program. In one embodiment, each program resides on a partitioned computer server although some or all programs may be consolidated on one or more servers. As such, each program is invisible to the other programs on that server. The administrator configures and installs the hardware, e-commerce software, and the profile wizards.

Once the program specific information has been provided and the administrator has created the program profile 122 to reflect these preferences, the administrator notifies the customer 126 and the approver preferably via email of the completion of program profile 122 creation. In one embodiment, the email to the approver contains a hyperlink to the program profile 122 needing approval. If the approver selects the hyperlink, the approver is taken directly to the program profile 122. If the approver has not already logged into the program website, the approver is prompted for a user name and password. The approver reviews the program profile 122 and consults with the administrator to resolve any discrepancies between the customer preferences and the created program profile 122. The approver notifies the administrator preferably via email after approving the created program profile 122.

After the program profile 122 has been approved, a website design team configures the identity and content of the program website. The design team adds relevant information to the program website such as rules and regulations, bulletin boards, graphical design elements, and feedback forms. Feedback forms gather participant 128 feedback to the program and redeeming experience.

The administrator accesses a catalog menu 330 to create at 332 the country-specific electronic catalogs according to the customer preferences, perform updates at 334 to the selections, and perform general maintenance at 336. Each electronic catalog contains logos, graphics, and text or other branding specific to the customer 126 associated with the electronic catalog. From the catalog menu, the administrator accesses a charges database 340 to obtain shipping, duty, and tax information or other relevant charges. The administrator also accesses a currency exchange database 338 to obtain exchange rate information for the currencies associated with the countries associated with the customer preferences. The charges database includes a maintainable set of tables containing these charges as provided by a shipping partner selected by the supplier. The tables are updated regularly, such as monthly, or can be updated in response to a change in fees by the shipping partner. When a manual update to the tables is required, the administrator creates and delivers a bulletin to each participant 128 to be automatically displayed when the participant 128 next logs into the program. The system 100 references the charges database when the administrator populates the electronic catalogs with the awards selected by the customer 126. The charges database and currency exchange database provide information to calculate the award point value of each selected award inclusive of the specific exchange rate for the country, shipping fees, duties, and taxes.

After creating the electronic catalogs, the administrator activates the program website and notifies the customer 126 preferably via email. The program profile 122 is also updated to show the status of program creation. Program operation commences on the award redemption start date.

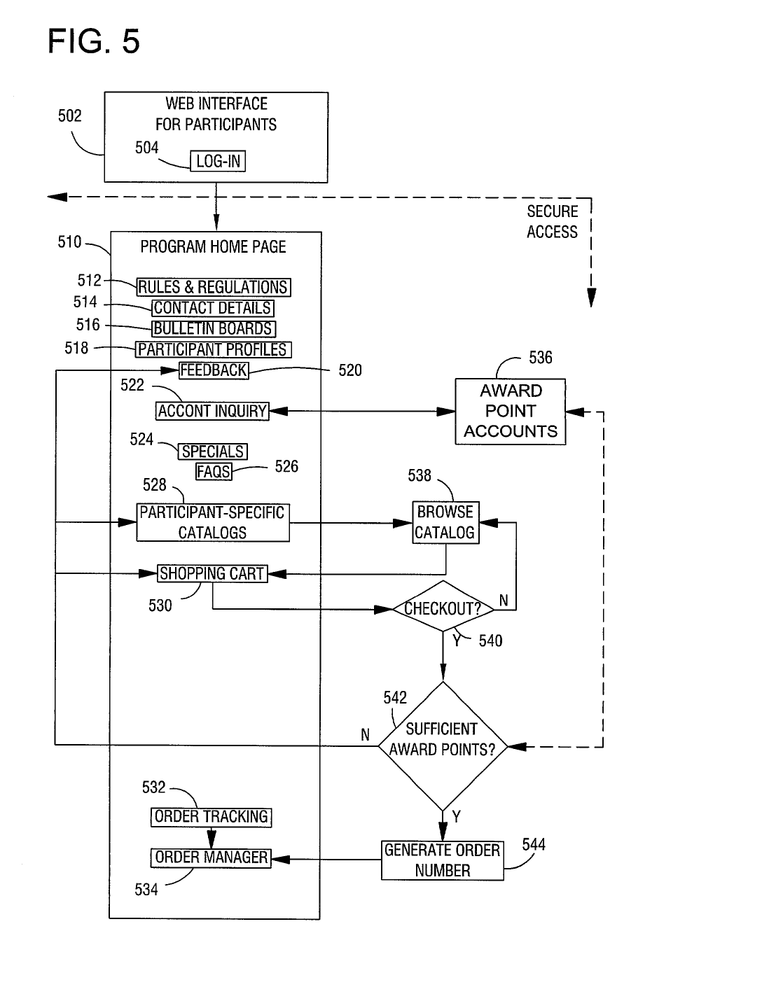

Each electronic catalog corresponds to a specific country and contains the awards selected by the customer 126 for that country. For example, as in FIG. 1, electronic catalogs can be created at 342 for the United Kingdom, France, Germany, Sweden, and Denmark. The participants 128 securely access at 344 the electronic catalogs through a web browser or other web interface by logging in at 346 with a user name and password (see FIG. 5 below).

From the application menu, the administrator edits or updates an existing program profile 122. The administrator can change the program duration specified by the end date, edit or update the participant profiles, add or remove countries for which a specific electronic catalog exists, and add or remove awards from the electronic catalogs. After specifying the changes, the administrator notifies the customer 126 and the approver preferably via email of the completion of program profile 122 editing. As with program profile 122 creation, the approver verifies that the changes correspond to the intent of the customer 126. The administrator also updates the history log to record the edits.

From the application menu, the administrator views the award database. The award database contains a listing of the available countries and the awards which are available in each country. The administrator updates the listing by adding, deleting, or modifying the available countries and/or awards.

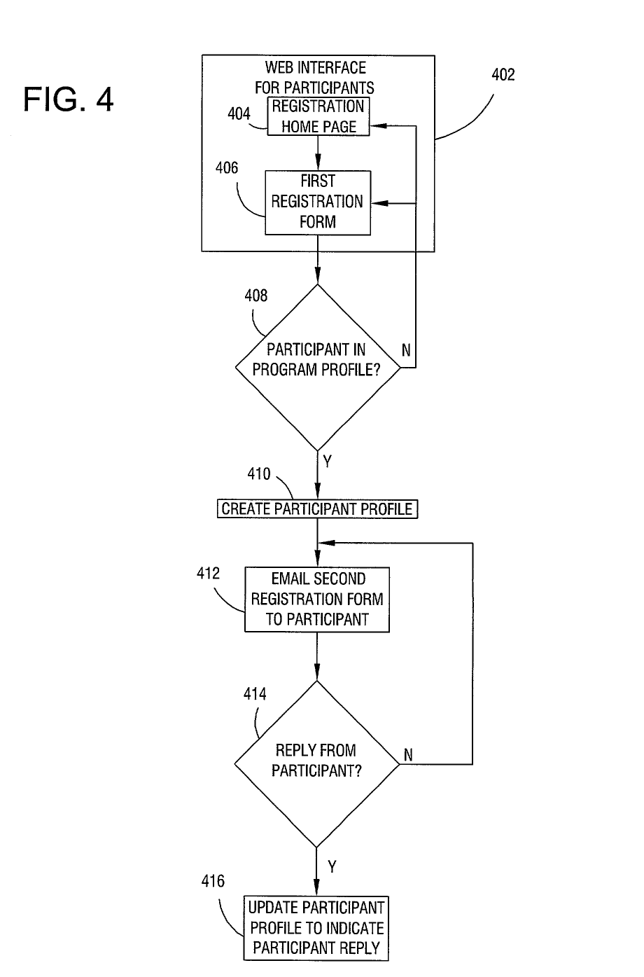

Referring next to FIG. 4, a flow chart illustrates participant 128 enrollment in the program to enable award redemption. The participants 128 securely access at 402 a registration home page 404 and a first registration form 406 through a web browser or other web interface by logging in with a user name and password. The first registration form includes terms and conditions of the program and requires validation information from the participant 128 such as the participant's name, address, and telephone number. If the participant 128 is listed at 408 in the program profile 122, then the participant 128 updates or otherwise creates at 410 a participant profile by entering specific information. A separate participant profile exists for each participant 128 and includes one or more of the following: the email address of the participant 128, the programs in which the participant 128 is enrolled, and the shipping address of the participant 128. After login and completion of the validation information, the participant 128 can immediately browse the electronic catalogs specified in the program profile 122 and the participant profile and views the award details for the awards in the specific electronic catalogs. If the participant 128 is not listed in the program profile 122, then the participant 128 returns to the registration home page 404 or the first registration form. A second registration form is sent at 412 preferably via email to the participant 128 if an email address has been specified in the participant profile. If the participant 128 has not specified an email address, the system 100 presents the participant 128 with options to register an email account or to receive a fax-back second registration form. The second registration form must be completed before the participant 128 is allowed to redeem awards. The second registration form displays the validation information obtained from the participant 128 on the first registration page. The participant 128 modifies or accepts the displayed validation information. The system 100 re-sends the second registration form to the participant 128 until a response is received or a preset maximum number of notifications have been sent. If the participant 128 completes and replies at 414 to the second registration form which validates the communication path to the participant 128, the participant profile is updated at 416 to indicate the information on the second registration form provided by the participant 128. At this point, the system 100 creates the award point account 124 for the newly-registered participant 128.

Referring next to FIG. 5, a flow chart illustrates participant 128 interaction with the program. Each participant 128 securely accesses at 502 a program home page 510 through a web browser or other web interface by logging in at 504 with a user name and password. The program home page 510 contains access to information regarding rules and regulations 512, contact details 514, bulletin boards 516, participant profiles 518, participant feedback 520, special offers 524, and a list of frequently asked questions and answers 526. The rules and regulations 512 display the terms and conditions of the program. The contact details 514 provide access to a returns form for returning redeemed awards. The bulletin boards 516 provide a messaging service to allow participants 128 to communicate with each other. The participant profiles 518 display the profile of the participant 128 currently logged in. The participant feedback 520 includes a form to be completed by the participant 128 to provide feedback on the program. The special offers 524 include, but are not limited to, promotions that are available only for a limited time.

The participant 128 also has the capability to perform a keyword search of the program website. The system 100 records in the participant profile each visit by the participant 128 to the program website. The participant 128 also performs account inquiries 522 by accessing at 536 the award point accounts, browses at 538 the electronic catalogs to which the participant 128 has access at 528, and views at 530 the contents of the shopping cart associated with the participant 128. While browsing the electronic catalogs available to the participant 128 as specified in the participant's participant profile, the participant 128 adds and deletes selected awards from the shopping cart. In one embodiment, the participants access a buyer's guide which compares the selected awards with other awards and award accessories within the same category and related categories. The shopping cart also includes an order memory which stores the contents of the shopping cart for future access by the participant 128. In particular, the order memory allows the participant 128 to redeem the same set of awards that were redeemed previously by that participant 128.

From the program home page 510, the participant 128 also accesses an order tracking function at 532 and an order manager at 534 to administer award redemption by the participant 128. The order tracking function allows each participant 128 to track the processing and fulfillment of that participant's orders. The order manager provides details of previous award redemptions by the participant 128. The order manager also allows the award partners to view all the orders the award partner is responsible for fulfilling.

The award point account 124 for the participants 128 displays the amount of the award points available to the participant 128 in response to an award inquiry by the participant 128. From the shopping cart function, the participant 128 proceeds to checkout at 540 or returns to browsing at 538 the electronic catalog. After proceeding to checkout, the system 100 accesses at 536 the award point account 124 of the participant 128 to determine at 542 if a sufficient amount of award points exists to redeem the selected awards in the shopping cart. If a sufficient amount of award points exists in the award point account 124 of the participant 128, the system 100 generates at 544 an order number for the redemption. If a sufficient amount of award points does not exist in the award point account 124 of the participant 128, the participant 128 returns to the shopping cart at 530, the electronic catalogs at 528, or to the feedback form at 520. For example, if the total price of the selected awards equals 100 award points and the redeeming participant 128 has 150 award points in his/her award point account 124, a sufficient amount of award points exists for the award redemption request. As such, the system 100 generates an order number and debits the award point account 124 by 100 award points. After the order number is generated, the system 100 directs the participants 128 to the order manager at 534. In one embodiment, the system 100 creates an invoice and the purchase order for the participant 128 using the order number. The award point account 124 of the participant 128 is debited by the total price of the selected awards after the participant 128 has confirmed checkout. The debiting occurs either in real-time or on a batch basis.

In one embodiment, each participant 128 securely accesses the program website through a wireless communications device enabled with a wireless application protocol (WAP). The wireless telecommunications devices include, but are not limited to, cellular telephones and personal digital assistants (PDA). The WAP-enabled telecommunications device provides the participant 128 with access to the program website. Through the WAP-enabled telecommunications device, the participant 128 performs all the functions available on the website including, but not limited to, redeeming awards and verifying the amount of award points in the participant's award point account 124. In other embodiments, the participant 128 redeems the award points for the awards via facsimile or mail.

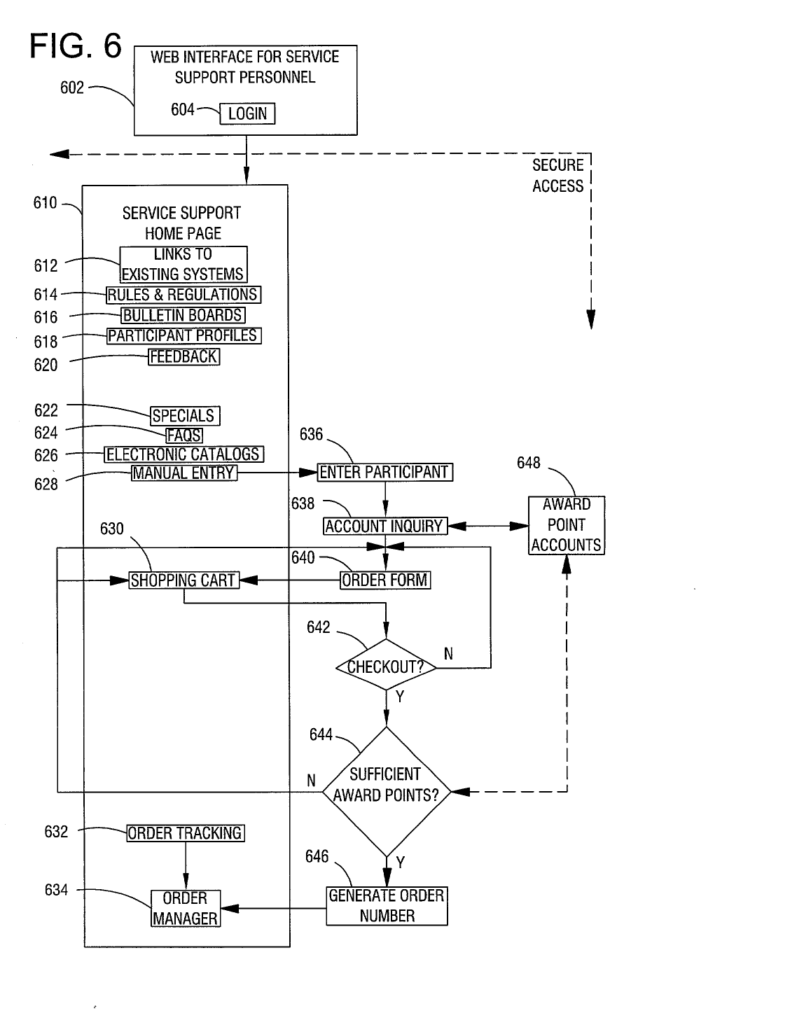

Referring next to FIG. 6, a flow chart illustrates service support center interaction with the program. The service support center employs service support personnel (SSP) to act on behalf of the participant 128 in accessing the program. The participant 128 communicates with the SSP through mail or telecommunications devices including, but not limited to, standard telephones, cellular telephones, or facsimile machines. Each SSP securely accesses at 602 a service support home page 610 through a web browser or other web interface by logging in at 604 with a user name and password. If the participant 128 has not registered for the program, then the SSP will not be able to redeem awards or access the award point account 124 of the participant 128. The SSP provides an unregistered participant with a fax-back second registration form as described above. The service support home page contains links to existing systems 612 and access to information regarding rules and regulations 614, bulletin boards 616, participant profiles 618, feedback 620, special offers 622, frequently asked questions and answers 624, and the electronic catalogs 626. Information associated with the rules and regulations 614, bulletin boards 616, participant profiles 618, feedback 620, special offers 622, and frequently asked questions and answers 624 is similar to the information available from the program home page 510 (see FIG. 5 and associated description). The electronic catalogs 626 include, but are not limited to, the catalogs available to the participant 128. Similarly, the existing systems 612 include the programs in which the participant 128 is enrolled.

Each SSP manually enters at 628 details about a specific participant 128 at 636 to perform at 638 account inquiries, view information at 648 regarding the award point account 124 of the specific participant 128, and access at 640 an order form. The award point account 124 for the participants 128 displays the amount of the award points available to the participant 128 in response to an award inquiry by the SSP. From the service support home page 610, the SSP views at 630 the contents of a shopping cart associated with the participant 128. The SSP adds and deletes selected awards from the shopping cart by selecting awards via the order form. From the service support home page 610, the SSP also accesses an order tracking function at 632 and an order manager at 634 to administer award redemption. From the shopping cart function, the SSP proceeds to checkout at 642 or returns to the order form at 640. After proceeding to checkout, the system 100 accesses at 648 the award point account 124 of the participant 128 to determine at 644 if a sufficient amount of award points exists to redeem the selected awards in the shopping cart. If a sufficient amount of award points exists in the award point account 124 of the participant 128, the system 100 generates at 646 an order number for the redemption. The SSP informs the participant 128 of the order number. If a sufficient amount of award points does not exist in the award point account 124 of the participant 128, the SSP returns to the shopping cart at 630 or to the order form at 640 where the SSP can remove awards or change the shopping cart accordingly. After the order number is generated, the system 100 directs at 634 the SSP to the order manager. The SSP records relevant information relating to the participant 128 in a rick text field or similar medium associated with the participant profile. Such relevant information includes, but is not limited to, the hostility level of the participant 128 and the number of times the participant 128 has made an inquiry.

In one embodiment, each customer 126 generates and/or receives paper or electronic progress reports. The progress reports yield data indicating information about activities of the customer's participants 128 within the program or summaries of all participants' activities for each program. Each customer 126 selects the frequency of progress report generation. In another embodiment, the registration home page 404, program home page 510, and/or service support home page 610 are accessible on or from a single page or combination of pages.

Those skilled in the art will recognize that the invention does not require one specific person to be the administrator with duties as described above. Any combination of people can perform the function of the administrator. Similarly, it is anticipated that many, if not all, of the functions of the administrator may be performed electronically via a processor interacting with each customer 126. That is, the customer 126 may create, modify, and operate the program electronically with the aid of a human administrator associated with the supplier.

In operation, the system 100 includes a method for operating the awards redemption program with at least one of the customers 126. Each customer 126 has at least one of the participants 128. The program has the award points redeemable for the awards. In one step, each customer 126 creates the program profile 122 defining at least one of the electronic catalogs having at least one of the awards selected from the collection of awards. In another step, each participant 128 accesses at least one of the electronic catalogs created by the customer 126 associated with the participant 128 in the language associated with the participant 128. In another step, each participant 128 requests the award redemption for at least one of the awards of the accessed electronic catalog. In another step, the system 100 processes the award redemption request. In another step, the system 100 fulfills the award redemption request. Each of the awards of the accessed electronic catalog has the price in award points inclusive of the charges associated with the redeeming participant 128.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A method for operating an awards redemption program having at least one customer, each customer having at least one participant, said program having award points redeemable for awards, said method comprising the steps of:
allowing each customer to create a program profile defining at least one electronic catalog having at least one award selected from a collection of awards;
allowing each participant to access at least one of the electronic catalogs created by the customer associated with the participant in a language associated with the participant;
allowing each participant to request an award redemption for at least one of the awards of the accessed electronic catalog;
processing the award redemption request; and
fulfilling the award redemption request, wherein each of the awards of the accessed electronic catalog has a price in award points inclusive of charges associated with the redeeming participant.

2. The method of claim 1, wherein the charges include taxes, duties, or shipping charges associated with the redeeming participant, and wherein the price reflects the exchange rate associated with the redeeming participant.

3. The method of claim 1, wherein the step of allowing each participant to access includes allowing each participant to access via a network at least one of the electronic catalogs created by the customer associated with the participant in a language associated with the participant.

4. The method of claim 1, wherein at least one of the customers is an international customer having participants in multiple countries, said international customer having a program profile which includes an electronic country catalog for each country identified by the customer, said electronic country catalog having at least one award selected from a collection of awards.

5. The method of claim 1, wherein the program profile includes a communications campaign modifiable by the customer, and wherein the communications campaign is presented to the participants of the customer when the participants access the electronic catalog.

6. The method of claim 5, wherein the program is accessible via a web page, wherein the communications campaign includes graphical elements associated with the web page and presented to the participants of the customer when the participants access the electronic catalog, and wherein the graphical elements are modifiable by the customer.

7. The method of claim 1, further comprising the step of allowing each customer to modify one or more of the following of the previously created program profile: program duration, participant information, countries for which a specific electronic catalog exists, and awards used in the program.

8. The method of claim 1, wherein the step of allowing each participant to request an award redemption includes the step of allowing each participant to request via a processor an award redemption for at least one of the awards of the accessed electronic catalog.

9. The method of claim 1, wherein the redeeming participant requests an award redemption via a wireless telecommunications device enabled with a wireless application protocol.

10. The method of claim 1, wherein the redeeming participant requests an award redemption via a service support center, wherein the service support center acts on behalf of the participant in redeeming the award points for awards.

11. The method of claim 1, further comprising the step of determining an allocation of award points for each participant.

12. The method of claim 11, wherein the determination is based on rules provided by the customer.

13. The method of claims 1 or 11, further comprising the step of issuing award points to each participant.

14. The method of claim 13, wherein the issuance is based on a determination by the customer of an allocation of award points for each participant.

15. The method of claim 1, further comprising the step of storing account information for each participant wherein the account information includes an amount of award points available to each participant, said account information of a particular participant available for review by the particular participant.

16. The method of claim 1, further comprising the step of storing account information for each participant wherein the account information includes data indicating transactions by each participant, said account information of a particular participant available for review by the particular participant.

17. The method of claim 1, further comprising the step of storing a participant profile associated with each customer wherein the participant profile includes one or more of the following: the email address of the participant, the programs in which the participant is enrolled, and the shipping address of the participant.

18. The method of claim 1, further comprising the step of allowing each participant to electronically enroll on-line in the program to enable award redemption.

19. The method of claim 18, further comprising the step of confirming participant enrollment via electronic mail.

20. A system for operating an awards redemption program having at least one customer, each customer having at least one participant, said program having award points redeemable for awards, said system comprising:
a creation system for allowing each customer to create a program profile defining at least one electronic catalog having at least one award selected from a collection of awards;
a storage system for allowing each participant to access at least one of the electronic catalogs created by the customer associated with the participant in a language associated with the participant;
a redemption system for allowing each participant to request an award redemption for at least one of the awards of the accessed electronic catalog;
a processing system for processing the award redemption request; and
a fulfillment system for fulfilling the award redemption request, wherein each of the awards of the accessed electronic catalog has a price in award points inclusive of taxes, duties, or shipping charges associated with the redeeming participant, and wherein the price reflects the exchange rate associated with the redeeming participant.

21. The system of claim 20, wherein the redemption system further comprises a service support center, wherein said service support center acts on behalf of the participant in redeeming the award points for awards.

22. The system of claim 20, further comprising an issuance system for issuing award points to each participant.

23. The system of claim 20, further comprising a modification system for modifying the program profile.

24. The system of claim 20, wherein the creation system, the storage system, the redemption system, the processing system, and the fulfillment system operate from one or more of a plurality of countries.

25. The system of claim 20, wherein the participants access the redemption system from one of a plurality of countries.

26. The system of claim 20, further comprising at least one award partner for delivering the requested awards, wherein the fulfillment system determines and authorizes the most cost effective award partner to deliver the requested awards.

27. The system of claim 20, wherein a catalog price of each award in award points to be displayed in the electronic catalogs is calculated by ((RP×UP)×BC/LCC+STC)×AP/BC=P, where RP is a retail price, UP is an uplift percentage, BC/LCC is a billing currency to local cost currency ratio, STC is a shipping and tax cost, AP/BC is an award point to billing currency ratio and P is said catalog price.

28. A system for operating an awards redemption program having at least one customer, each customer having at least one participant, said program having award points redeemable for awards, said system comprising:
means for allowing each customer to create a program profile defining at least one electronic catalog having at least one award selected from a collection of awards;
means for allowing each participant to access at least one of the electronic catalogs created by the customer associated with the participant in a language associated with the participant;
means for allowing each participant to request an award redemption for at least one of the awards of the accessed electronic catalog;
means for processing the award redemption request; and
means for fulfilling the award redemption request, wherein each of the awards of the accessed electronic catalog has a price in award points inclusive of charges associated with the redeeming participant.
